(19) United States
(12) Patent Application Publication
(10) Pub. No.: US 2009/0153487 A1
(43) Pub. Date: Jun. 18, 2009

(54) DATA INPUT DEVICE HAVING A PLURALITY OF KEY STICK DEVICES FOR FAST TYPING AND METHOD THEREOF

(76) Inventors: ADAM M. GUNTHER, Raleigh, NC (US); Hugh E. Hockett, Raleigh, NC (US); Eric Kirchstein, Raleigh, NC (US)

Correspondence Address: DILLON & YUDELL LLP, 8911 N. CAPITAL OF TEXAS HWY., SUITE 2110, AUSTIN, TX, 78759, US

(21) Appl. No.: 11/955,042

(22) Filed: Dec. 12, 2007

(51) Int. Cl. G06F 3/02

(52) U.S. Cl. 345/168

(57) ABSTRACT

A data input device and associated method for fast typing. The data input device includes a keyboard having a plurality of key stick devices for entering data. A sensor element is coupled to each key stick device in a first position. The sensor element is responsive to a change in at least one azimuth and tilt angle of one of the plurality of key stick devices. The at least one azimuth and tilt angle, which defines the resulting position of the key stick device, represents an input mode for one of the plurality of key stick devices. The input mode is formed by tilting one of the plurality of key stick devices relative to the keyboard. The (i) change in the azimuth and/or tilt angle, and (ii) a return to the first position, when combined, correspond to a selection of a conventional key.

### BACKGROUND OF THE INVENTION

The present disclosure relates to the field of computers, and specifically to data input devices.

Typing is the process of inputting text into a device, such as a typewriter, computer, or a calculator, by pressing keys on a keyboard. It can be distinguished from other means of input, such as the use of pointing devices like the computer mouse, and text input via speech recognition. A common typing technique, known as touch typing, is typing without using the sense of sight to find the keys. Specifically, a touch typist will know his/her location through muscle memory. Touch typing usually places eight fingers (two of each index finger, middle finger, ring finger, and little finger) in a horizontal row along the middle of the keyboard (known as the home row) and has the typist reach for other keys. Most conventional computer keyboards have a raised dot or bar on either the F/J keys or the D/K keys (or the keys in the same relative position, for non-QWERTY keyboards) so that touch-typists can feel the F/J keys or the D/K keys when their fingertips are over the correct home row.

In recent years, emphasis has been placed on making computers both smaller and more user-friendly. Although numerous efforts have been made to alter the size, number, arrangement, and functions of keys on a keyboard, none of these attempts appear to have been commercially successful, and the conventional “QWERTY” keyboard remains the standard in the industry.

### BRIEF SUMMARY OF THE INVENTION

A data input device and associated method for fast typing are disclosed. The data input device includes a keyboard having a plurality of key stick devices for entering data. A sensor element is coupled to each key stick device in a first position. The sensor element is responsive to a change in at least one azimuth and tilt angle of one of the plurality of key stick devices. The at least one azimuth and tilt angle, which defines the resulting position of the key stick device, represents an input mode for one of the plurality of key stick devices. The input mode is formed by tilting one of the plurality of key stick devices relative to the keyboard. The (i) change in the azimuth and/or tilt angle, and (ii) a return to the first position, when combined, correspond to a selection of a conventional key.

### BRIEF DESCRIPTION OF THE SEVERAL VIEWS OF THE DRAWINGS

Aspects of the invention itself will best be understood by reference to the following detailed description of an illustrative embodiment when read in conjunction with the accompanying drawings, where:

FIG. 1 depicts an exemplary computer in which the present invention may be implemented;

FIG. 2 depicts a perspective view of an exemplary data input device in which the present invention may be implemented;

FIG. 3 is a top view of the exemplary data input device shown in FIG. 2 in which the present invention may be implemented;

FIG. 4 depicts a partial view of an arrangement of conventional keys in an exemplary QWERTY keyboard that is useful for understanding the invention;

FIG. 5 is a perspective view of an exemplary key stick device depicting various input modes, according to an embodiment of the present invention;

FIG. 6 is a perspective view of the exemplary key stick device of FIG. 5 at various input modes correlating to various detent positions that is useful for understanding the invention;

FIG. 7 illustrates an exemplary position grid depicting detent positions relative to an exemplary key stick device and how a combination of detent positions correlate to a unique conventional key;

FIG. 8A is a perspective view of another exemplary data input device having an extra key stick device, according to an embodiment of the present invention;

FIG. 8B depicts a numeric keypad in conjunction with the extra key stick device shown of FIG. 8A that is useful for understanding the invention; and

FIG. 9 is a high-level flow-chart of exemplary method steps taken for fast typing using a keyboard, according to an embodiment of the present invention.

### DETAILED DESCRIPTION OF THE INVENTION

As will be appreciated by one skilled in the art, the present invention may be embodied as a method, apparatus (system), or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module”, “device”, or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java® (JAVA is a trademark or registered trademark of Sun Microsystems, Inc. in the United States and other countries), Smalltalk® (SMALLTALK is a trademark or registered trademark of Cincom Systems, Inc.), C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

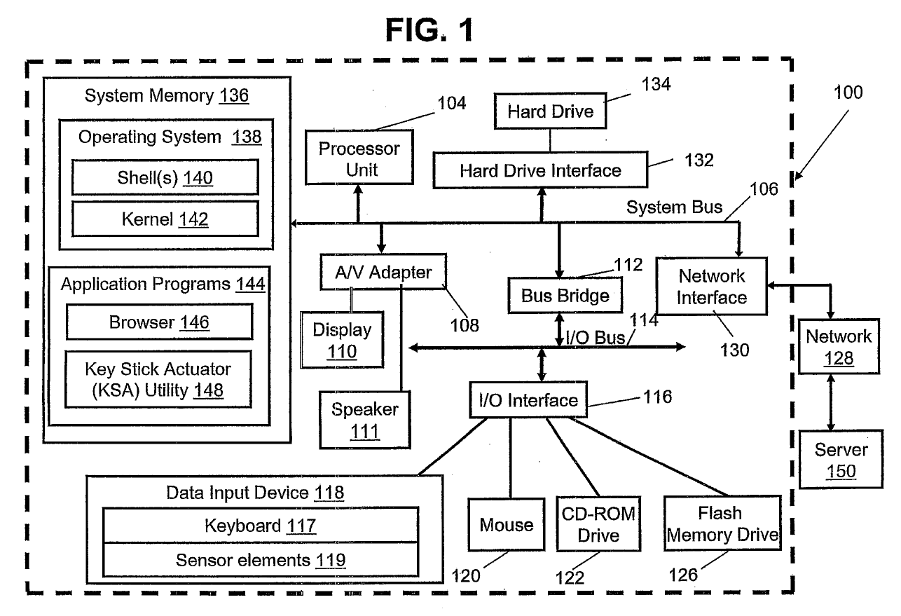

With reference now to the figures, and in particular to FIG. 1, there is depicted a block diagram of an exemplary computer 100, with which the present invention may be utilized. Computer 100 includes a processor unit 104 that is coupled to a system bus 106. An audio/video (A/V) adapter 108, which drives/supports a display 110 and a speaker 111, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a data input device 118 (which includes a keyboard 117 and a sensor element 119), a mouse 120, a Compact Disk-Read Only Memory (CD-ROM) drive 122, and a flash memory drive 126. The format of the ports connected to I/O interface 116 may be any known to those skilled in the art of computer architecture, including but not limited to Universal Serial Bus (USB) ports.

Computer 100 is able to communicate with a server 150 via a network 128 using a network interface 130, which is coupled to system bus 106. Network 128 may be an external network such as the Internet, or an internal network such as an Ethernet or a Virtual Private Network (VPN). Server 150 may be architecturally configured in the manner depicted for computer 100.

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX® (UNIX is a registered trademark of The Open Group in the United States and other countries)) is a program that provides an interpreter and an interface between the user and the operating system. Shell 140 provides a system prompt, interprets commands entered by mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

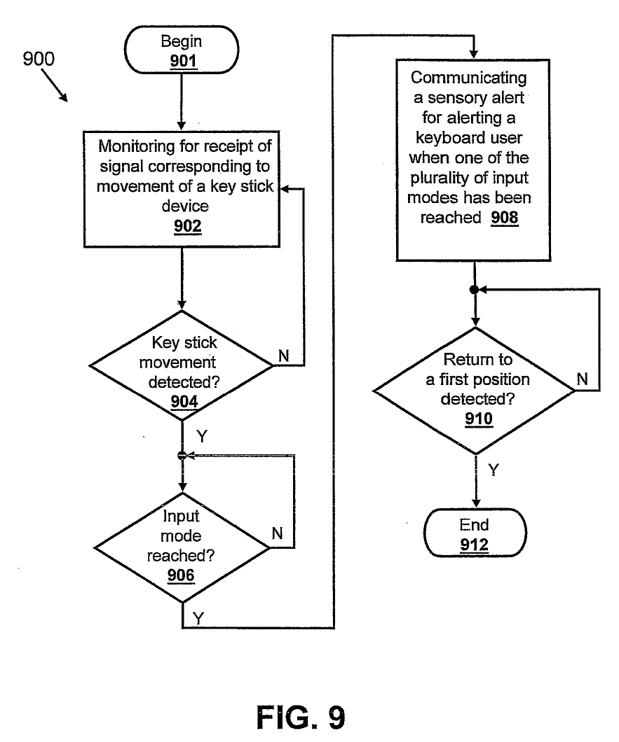

Application programs 144 include a browser 146. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. Application programs 144 in system memory 136 also include a Key Stick Mode (KSM) Utility 148. KSM utility 148 performs the functions illustrated below in FIG. 9. KSM utility 148 communicates with OS 138, which in turn communicates with I/O Interface 116 by way of system bus 106, bus bridge 112, and I/O Bus 114. I/O Interface communicates with Data Input Device 118. KSM utility 148 generates electronic signals in response to the actuation of key stick devices (discussed below) of keyboard 117.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

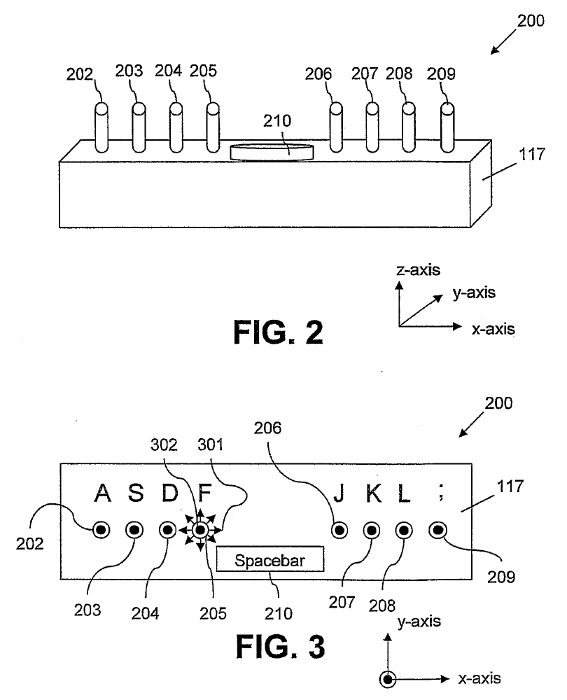

Referring now to FIG. 2, a graphical representation of an exemplary data input device 200 is shown. Data input device 200 includes a keyboard 117 having a plurality of key stick devices 202-209 and a spacebar key 210. In addition, data input device 200 includes a plurality of sensor elements 119 (FIG. 1). Initially, each sensor element 119 is coupled to a respective key stick device 202-209 at a first position and to spacebar key 210 at a first position. Each sensor element is responsive to actuation of a respective key stick device 202-209. The actuation of key stick device 202-209 produces a change in one or more of an azimuth, a tilt angle, and a height of key stick device 202-209. Actuation can be produced by either: (a) depressing key stick device 202-209, which results in a change in height of key stick device 202-209, or (b) tilting key stick device 202-209 relative to keyboard 117, which results in a change in an azimuth and/or a tilt angle.

The height, azimuth, and tilt angle of key stick device 202-209 represents one of a plurality of input modes. The (i) change in the height, azimuth, and/or tilt angle, and (ii) a return to the first position, when (i) and (ii) are combined, correspond to a selection of a unique conventional key. The term “unique conventional key” refers to a key that is typically utilized in a conventional keyboard. Such keys include, but are not limited to: a typewriter key, a WINDOWS® (a registered trademark of Microsoft Corp.) key, an application key, a function key, a numeric keypad key, a cursor control key, an enter key, a command key, or a spacebar key 210. Moreover, such conventional keys are typically arranged in a conventional layout, such as in the case of a QWERTY layout or a DVORAK layout.

Referring now to FIG. 3, a top view of exemplary data input device 200 is shown. According to this embodiment of the invention, key stick devices 202-209 are arranged in a home row that is similarly arranged as would be typically represented by home row keys ‘A’, ‘S’, ‘D’, ‘F’, ‘J’, ‘K’, ‘L’, ‘;’ that are arranged in a QWERTY layout. Each key stick device 202-209, can be positioned (i.e., tilted and/or depressed) from an initial position (e.g., upright along a z-axis). For illustrative purposes only, key stick device 205 is shown having directional arrows 301 and dot 302. Directional arrows 301 indicate the various azimuths in which key stick device 205 can be urged (or positioned). Dot 302 indicates that key stick device 205 can be pushed-down by a keyboard user, thus producing a change in a positional height of key stick device 205. When key stick device 205 is pushed-down and then returns (i.e., by spring recoil and the like) to a first position, a selection of the conventional alphanumeric key ‘F’ is made. It should be recognized that while the above example focuses on the possible actuated movements of key stick device 205, any one of key stick devices 202-204 and 206-209 can be positioned by a keyboard user as illustrated by key stick device 205.

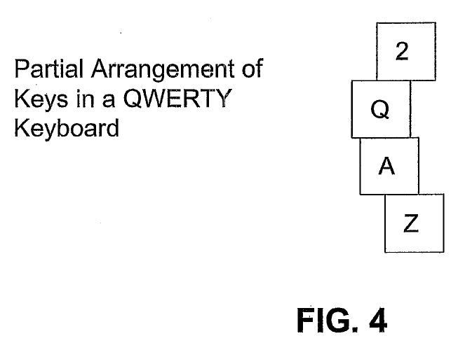

To better illustrate the functionality of key stick devices 202-209, a partial arrangement of conventional keys associated with a QWERTY layout is shown in FIG. 4. In this partial view of a QWERTY layout, conventional keys ‘Z’, ‘A’, ‘Q’, and ‘2’ are shown as they are typically arranged. In a QWERTY layout, the ‘A’ key forms part of what is commonly known as a home row (i.e., keys A, S, D, F, G, H, J, K, L) of keys. Below and to the right of the ‘A’ key is the ‘Z’ key. Above the ‘A’ key is the ‘Q’ key, which is in turn below and to the right of the ‘2’ key. Thus, conventional keys ‘Z’, ‘A’, ‘Q’, and ‘2’ each form part of distinct rows of keys. While it is recognized that the QWERTY layout and its international variants is currently the most common type of keyboard key layout that is implemented, the invention is not limited in this regard, and other conventional keyboard key layouts that are familiar to a keyboard user can also be used in combination with the invention.

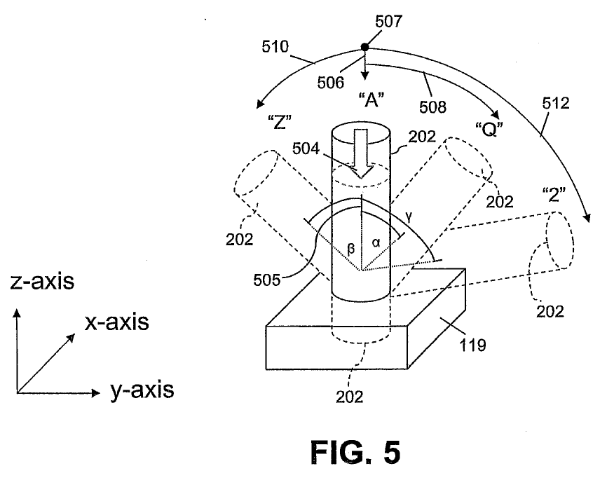

Referring now to FIG. 5, key stick device 202 (FIG. 2) is shown. Key stick device 202 is coupled to sensor element 119. When key stick device 202 is pushed down along a z-axis (as shown by arrows 504 and 506), sensor element 119 detects this push-down motion. As a result of this push-down motion, the positional height of key stick device 205 relative to an initial position is changed. When key stick device 202 returns to a first position, sensor element 119 generates an electronic signal (i.e., such as in the form of conventional ASCII code) representing data for inputting the letter ‘A’. In another example, key stick device 202 is tilted towards a north azimuth along a y-axis. In addition to tilting towards a north azimuth, key stick device 202 also tilts (i.e., movement along directional path 508) at an angle (or tilt angle) α of 45 degrees. Generally, the tilt angle is measured with respect to a longitudinal axis 505. When key stick device 202 returns to a first position, sensor element 119 generates an electronic signal representing data for inputting the letter ‘Q’. The combination of: (i) changing one or more of the aforementioned variables (i.e., positional height, azimuth, and tilt angle), which collectively form an input mode, and (ii) returning key stick device 202 to a first position indicates a selection of a unique conventional key (e.g., the letter ‘Q’).

Similarly, when the ‘Z’ key is to be represented by an input mode, sensor element 119 detects the tilting (i.e., movement along directional path 510) of key stick device 202 towards a south azimuth and at a tilt angle β of 45 degrees from longitudinal axis 505. Moreover, when the ‘2’ key is to be represented by an input mode, sensor element 119 detects the tilting of key stick device 202 towards a north azimuth, but at a tilt angle that is greater than the 45 degrees that is required to represent the ‘Q’ key. In this regard, key stick device 202 is tilted (i.e., movement along directional path 512) at a tilt angle γ of about 80 degrees from longitudinal axis 505. Generally, the movement of key stick device 202 from a first position to a second position is in a direction of a relative position of a desired conventional key on a conventional keyboard. Thus, with a single key stick device 202, a plurality of unique conventional keys can be represented. Sensor element 119 can be implemented in various ways, including, but not limited to the use of: a force sensor or piezoelectric sensor, which converts pressure, weight, and forces towards a measurable electrical quantity (i.e., resistance) and any type of position sensor mechanism that can detect a physical change in the movement of key stick devices 202-209 and convert the physical change into a measurable electrical quantity.

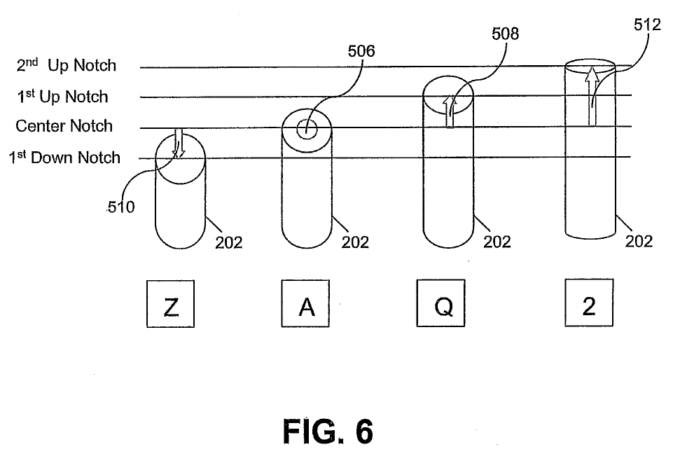

To facilitate a computer user's identification of one of the various possible input modes associated with a particular key stick device 202-209, a detent mechanism (not shown) for resisting movement can be utilized. According to one embodiment, the detent mechanism for resisting movement includes a spring-loaded ball bearing that locates in small incremental depressions/notches. With reference now to FIG. 6, key stick device 202 (FIG. 2) is shown in four distinct input modes. Each one of the four distinct input modes indicates a unique conventional key, ‘Z’, ‘A’, ‘Q’, or ‘2’. Moreover, each distinct input mode shown in FIG. 6 is attained by tracing the movement of key stick device 202 to locate the depression/notch (not shown) which, when located, identifies when a particular input mode has been reached. Key stick device 202 reaches input modes representing unique conventional keys ‘Z’, ‘A’, ‘Q’, or ‘2’ by moving from an initial position through directional paths 510, 506, 508, and 512 of FIG. 5, respectively. For instance, if key stick device 202 is to start from an initial position (e.g., as shown by upright and non-depressed key stick device 202 in FIG. 5), key stick device 202 must first unlock from a center notch and be actuated along directional path 512. Along directional path 512, key stick device reaches and unlocks from a 1^{st} Up Notch until a 2^{nd} Up Notch is reached.

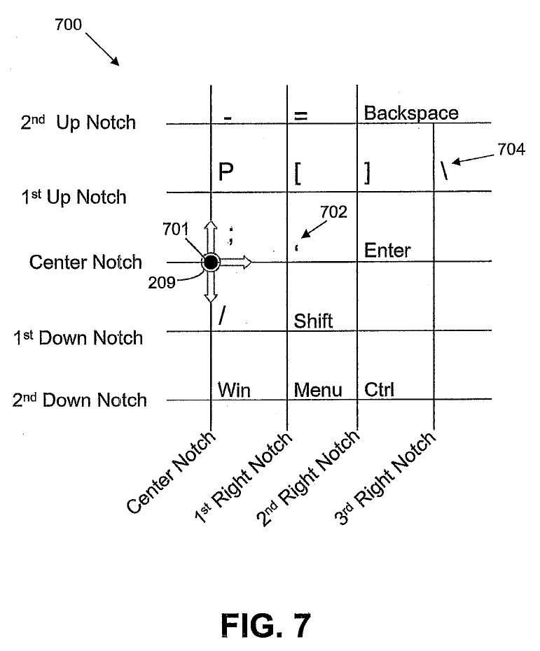

It is important to note that there can be any number of input modes that can be associated with a single key stick device 202-209. The exemplary embodiments illustrated thus far have shown how the key stick device can be tilted in a direction of a North/South azimuth to attain input modes corresponding to unique conventional keys. However, key stick device 202-209 can also be tilted in a direction of an East/West azimuth, or in any combination of North/South/East/West azimuths. Referring now to FIG. 7, an exemplary position grid 700 depicting detent positions relative to exemplary key stick device 209 is shown. According to exemplary position grid 700, key stick device 209 can be positioned such that up to sixteen input modes corresponding respectively to sixteen unique conventional keys can be reached. For example, when key stick device 209 is tilted from an initial position 701 along an East azimuth until reaching a 1^{st} Right Notch, an input mode corresponding to a unique conventional key (i.e., quotation key 702) is reached. Moreover, in order for an input mode corresponding to a conventional backslash “\” key 704 to be reached, key stick device 209 can move along any number of directional paths from an initial position: (i) moving in a direction of an East azimuth until reaching a 3^{rd} Right Notch position, and from the 3^{rd} Right Notch position moving in a direction of a North azimuth until reaching a 1^{st} Up Notch position; or (ii) moving in a direction of the North azimuth until reaching the 1^{st} Up Notch position, and from the 1^{st} Up Notch position moving in a direction of an East azimuth until reaching the 3^{rd} Right Notch position.

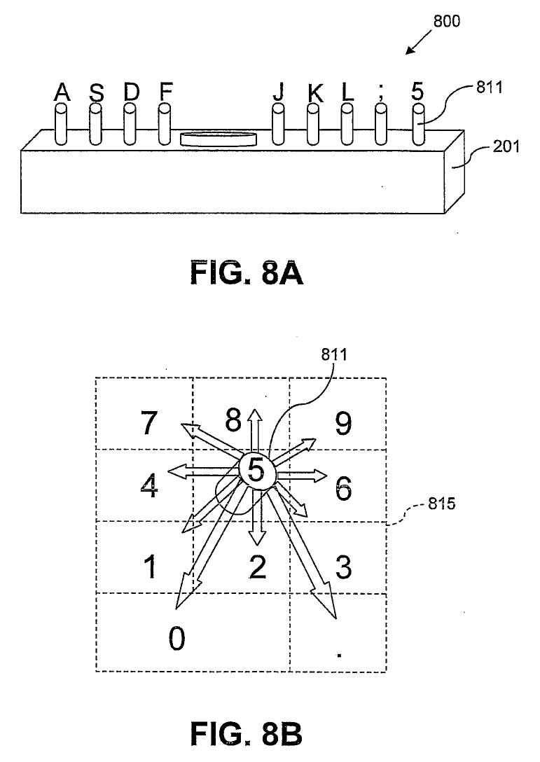

It should also be understood that the number of key stick devices included in keyboard 117 can vary. For example, another embodiment 800 of an exemplary data input device 800 is shown in FIG. 8A. Data input device 800 includes an extra key stick device 810 coupled to keyboard 117 (of FIG. 2) that facilitates the selection of unique conventional keys corresponding a numeric keypad 815 (FIG. 8B). With reference to FIG. 8B, the dashed lines of numeric keypad 815 are intended to convey the idea that the numeric keypad is not actually included with data input device 800 of FIG. 8A. Instead, numeric keypad 815 is meant to illustrate how movements (i.e., tilting and/or depressing) of key stick device 810 would correspond to a selection of a unique conventional key on a conventional keypad.

As described in exemplary manner below, the invention also provides for a method for fast typing. With reference now to FIG. 9, a high-level flow-chart 900 of the method is shown. After initiator block 901, KSM utility 148 (FIG. 1) monitors for receipt of signal corresponding to movement of key stick device 202-209, as depicted in block 902. From block 902, method 900 proceeds to decision block 904, where a determination is made whether the movement of key stick device 202-209 is detected. If movement of key stick device 202-209 is not detected, method 900 returns to block 902 until the signal is received by KSM utility 148. However, if movement of key stick device 202-209 is detected, method 900 proceeds to decision block 906, where a determination is made whether one of a plurality of input modes has been reached. If an input mode has not been reached, method 900 continues at block 906 until the input mode is reached.

Each one of the plurality of key stick devices 202-209 are positioned by a keyboard user in one of a plurality of input modes. Each one of the plurality of input modes indicates a unique conventional key that corresponds to a change in a height, an azimuth, and/or a tilt angle of one of the plurality of key stick devices 202-209. If an input mode is reached (from decision block 906), method 900 proceeds to block 908, where a sensory alert is communicated to a keyboard user, as depicted in block 908. The sensory alert alerts a keyboard user when one of the plurality of input modes has been reached.

The sensory alert may take several possible forms. In one embodiment, the sensory alert is a tactile sensory alert. The tactile sensory alert includes a detent mechanism coupled to one of the plurality of key stick devices 202-209. According to another embodiment, the tactile sensory alert includes a vibrating mechanism coupled to one of the plurality of key stick devices 202-209. In both types of tactile sensory alerts, the alerts tactilely indicate to the keyboard user which one of the plurality of input modes has been reached. In addition to tactile sensory alerts, the sensory alert can support other types of sensory alerts, such as audible and visual sensory alerts. For example, an audible sensory alert, via speaker 111 (FIG. 1), communicates the unique conventional key that corresponds to the input mode that has been reached. A visual sensory alert includes displaying, via display 110 (FIG. 1), the unique conventional key that corresponds to the input mode that has been reached. After communicating the sensory alert when one of the plurality of input modes has been reached, method 900 continues to decision block 910, where a determination is made whether key stick device 202-209 returns to a first position. In this regard, key stick device 202-209 can return to the first position as a result of a recoil mechanism associated with key stick device 202-209 or by user actuation. Method 900 continues in decision block 910 until a return to a first position is detected. Method 900 ends at terminator block 912.

Note that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A data input device comprising:
a keyboard having a plurality of key stick devices for entering data;
a sensor element coupled to each of said plurality of key stick devices in a first position;
wherein said sensor element is responsive to a change in at least one azimuth and tilt angle formed by tilting one of said plurality of key stick devices relative to said keyboard;
wherein said at least one azimuth and tilt angle represent one of a plurality of input modes; and
wherein said change in the at least one azimuth and tilt angle, and a return to said first position correspond to a selection of a unique conventional key.

2. The data input device of claim 1, wherein said input mode is produced by a movement of one of said plurality of key stick devices from said first position to a second position, and wherein said movement is in a direction of a relative position of a desired key on a conventional keyboard.

3. The data input device of claim 1, wherein the unique conventional key includes a typewriter key, or a WINDOWS key, or an application key, or a function key, or a numeric keypad key, or a cursor control key, or an enter key, or a command key, or a spacebar key.

4. The data input device of claim 1, further comprising a detent mechanism coupled to each one of said plurality of key stick devices to tactilely indicate to a user one of a plurality of input modes.

5. A method for fast typing, the method comprising:
monitoring for receipt of a signal corresponding to a movement of one of a plurality of key stick devices from a first position;
detecting said movement of one of said plurality of key stick devices from said first position;
responsive to said movement of one of said plurality of key stick devices from said first position, determining one of a plurality of input modes;
wherein each one of said plurality of input modes indicates a unique conventional key, said unique conventional key corresponding to a change in an azimuth or a tilt angle of said one of said plurality of key stick devices.

6. The method of claim 5, the method further comprising:
detecting a return of said one of said plurality of key stick devices to said first position;
wherein said change in said one azimuth or tilt angle, and said return of one of said plurality of key devices to said first position correspond to a selection of said unique conventional key.

7. The method of claim 5, the method further comprising:
communicating a sensory alert for alerting a keyboard user when one of said plurality of input modes has been reached.

8. The method of claim 7, wherein the sensory alert is a tactile sensory alert.

9. The method of claim 8, wherein the tactile sensory alert is a detent mechanism coupled to one of said plurality of key stick devices to tactilely indicate to a user one of said plurality of input modes.

10. The method of claim 9, wherein the tactile sensory alert is a vibrating mechanism coupled to one of said plurality of key stick devices to tactilely indicate to a user one of said plurality of input modes.

11. The method of claim 7, wherein the sensory alert is an audible sensory alert to audibly indicate to a user one of said plurality of input modes.

12. The method of claim 7, wherein the sensory alert is a visual sensory alert to visually indicate to a user one of said plurality of input modes.
